(19) United States
(12) Patent Application Publication
(10) Pub. No.: US 2025/0078587 A1
(43) Pub. Date: Mar. 6, 2025

(54) VIN-BASED AUTO-CALIBRATION FOR TELEMATICS DEVICE

(71) Applicant: GEOMETRIS LP, Houston, TX (US)

(72) Inventors: Narayan Manish Desai, Houston, TX (US); Manish Jagdish Desai, Houston, TX (US)

(21) Appl. No.: 18/461,799

(22) Filed: Sep. 6, 2023

(51) Int. Cl. G07C 5/08; G07C 5/00

(52) U.S. Cl. CPC G07C 5/0841; G07C 5/008

(57) ABSTRACT

A method for automatically calibrating a telematics device in a vehicle includes obtaining, from a vehicle device of the vehicle, a vehicle identification number (VIN) and retrieving a set of vehicle data using the VIN. The method also includes making a first determination that a first portion of vehicle characteristic data is included in the set of vehicle data. Further, the method includes setting event detection parameters for the telematics device based on the first portion of vehicle characteristic data.

### BACKGROUND

Tracking vehicle behavior is valuable to parties interested in how the vehicle is being used. However, vehicles come in many different shapes and sizes and have varying capabilities. For example, when safely operating under the same external conditions, a smaller vehicle may experience a greater magnitude of acceleration during a maneuver compared to a larger vehicle due, at least in part to the weight differences between the two vehicles.

### SUMMARY

In general, embodiments described herein relate to a method for automatically calibrating a telematics device in a vehicle. The method includes obtaining, from a vehicle device of the vehicle, a vehicle identification number (VIN), retrieving a set of vehicle data using the VIN, and determining whether a gross vehicle weight rating (GVWR) is included in the set of vehicle data. The method also includes setting a first group of event detection parameters for the telematics device based on the GVWR if the GVWR is included in the set of vehicle data. Further, the method includes determining whether a vehicle type or a body class is included in the set of vehicle data if the GVWR is not included in the set of vehicle data. In addition, the method includes determining whether a number of engine cylinders is included in the set of vehicle data if the GVWR is not included in the set of vehicle data. Moreover, the method includes setting a second group of event detection parameters based on the vehicle type or the body class and number of engine cylinders if the vehicle type or the body class and the number of engine cylinders are included in the set of vehicle data. Also, the method includes determining whether an engine displacement or an engine power is included in the set of vehicle data if the vehicle type or the body class is included in the set of vehicle data and the number of engine cylinders is not included in the set of vehicle data or if the vehicle type or the body class is not included in the set of vehicle data. The method further includes setting a third group of event detection parameters based on the vehicle type or the body class and the engine displacement or the engine power if the vehicle type or the body class and the engine displacement or the engine power is included in the set of vehicle data and the number of engine cylinders is not included in the set of vehicle data. In addition, the method includes setting a fourth group of event detection parameters based on the vehicle type or the body class if the vehicle type or the body class is included in the set of vehicle data and the number of engine cylinders, the engine displacement, and the engine power are not included in the set of vehicle data. Moreover, the method includes setting a fifth group of event detection parameters based on the number of engine cylinders and the engine displacement or the engine power if the number of engine cylinders and the engine displacement or the engine power are included in the set of vehicle data and the vehicle type, and the body class are not included in the set of vehicle data. The method also includes setting a sixth group of event detection parameters based on the number of engine cylinders if the number of engine cylinders is included in the set of vehicle data and the vehicle type, the body class, the engine displacement, and the engine power are not included in the set of vehicle data. Further, the method includes setting a seventh group of event detection parameters based on the engine displacement or the engine power if the engine displacement or the engine power are included in the set of vehicle data and the vehicle type, the body class, and the number of engine cylinders are not included in the set of vehicle data. In addition, the method includes setting an eighth group of event detection parameters to a default setting if the vehicle type, the body class, the number of engine cylinders, the engine displacement, and the engine power are not included in the set of vehicle data.

In general, embodiments described herein relate to a method for automatically calibrating a telematics device in a vehicle. The method includes obtaining a vehicle identification number (VIN) and retrieving a set of vehicle data using the VIN. The method also includes making a first determination that a first portion of vehicle characteristic data is included in the set of vehicle data. Further, the method includes setting event detection parameters for the telematics device based on the first portion of vehicle characteristic data.

In general, embodiments described herein relate to a system for automatically monitoring vehicle behavior. The system includes a telematics device communicatively coupled to a vehicle. The telematics device includes a memory and a processor programmed to obtain, from a vehicle device of the vehicle, a vehicle identification number (VIN) and retrieve a set of vehicle data using the VIN. The processor is also programmed to make a first determination that a first portion of vehicle characteristic data is not included in the set of vehicle data. In addition, the processor is programmed to set event detection parameters for the telematics device. Moreover, the processor is programmed to monitor, using the telematics device, vehicle behavior of the vehicle. Also, the processor is programmed to make a second determination that a threshold value of the event detection parameters has been exceeded based on the monitoring. Further, the processor is programmed to generate, in response to the second determination, a log of vehicle behavior.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments.

FIG. 2 shows a diagram of a telematics device in accordance with one or more embodiments.

FIGS. 3.1-3.4 show a flowchart of a method for automatically setting event parameters and detecting events outside of the event parameters in accordance with one or more embodiments.

FIG. 4 shows a computing system in accordance with one or more embodiments.

### DETAILED DESCRIPTION

In the below description, numerous details are set forth as examples of embodiments described herein. It will be understood by those skilled in the art, and having the benefit of this Detailed Description, that one or more embodiments of embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Tracking vehicle behavior is valuable to parties interested in how the vehicle is being used. For example, a manager of a fleet of vehicles is unable to be present during the operation of each and every vehicle in the fleet. Likewise, an insurance company may be interested in how a particular vehicle is used for underwriting purposes. However, vehicles come in many different shapes and sizes and have varying capabilities. For example, when safely operating under the same external conditions, a smaller vehicle may experience a greater magnitude of acceleration during a maneuver compared to a larger vehicle due, at least in part to the weight differences between the two vehicles.

In addition, collecting all of the data of a vehicle's behavior creates too much data that is cumbersome to store and track. As such, systems and methods disclosed herein provide for collecting and logging vehicle behavior only when certain thresholds are exceeded (e.g., event detection parameters) such that only events of note are stored and tracked. In addition, as described above, different vehicles have different capabilities and are thus operated differently. As such, threshold values for one vehicle might be too high for another vehicle and simultaneously too low for yet another vehicle. As such, the thresholds should be based on characteristics of the vehicle. Systems and methods disclosed herein provide for automatically detecting vehicle characteristics and setting the thresholds based on the vehicle characteristics, thereby customizing the thresholds to the particular vehicle and simultaneously reducing false positives (i.e., logging events that are not of concern) and false negatives (i.e., not logging events that are of concern.

The following describes one or more embodiments.

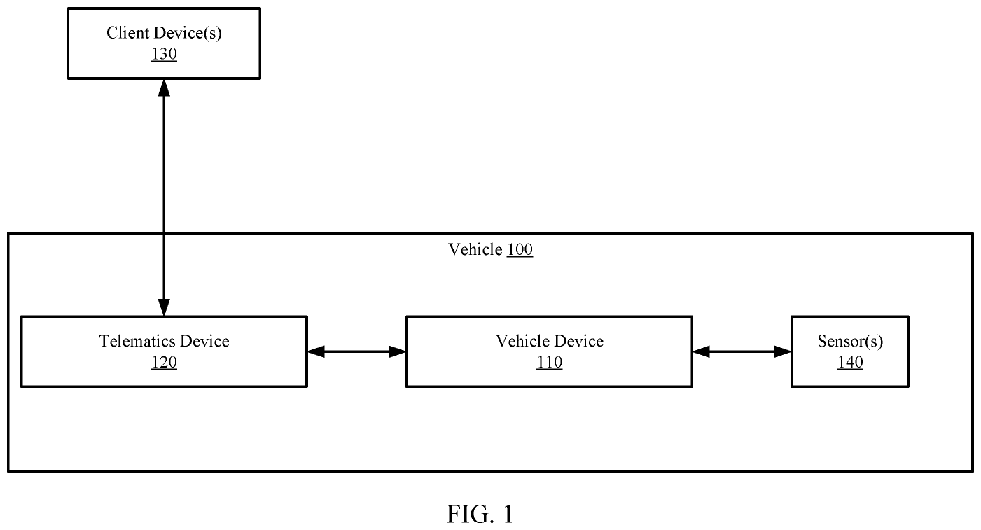

FIG. 1 shows an example system in accordance with one or more embodiments. The system includes a client device (130), and a vehicle (100) that includes a telematics device (120), a vehicle device (110), and one or more sensors (140). The system may include additional, fewer, and/or different components without departing from the scope of the disclosure. Each component may be operably connected to any of the other components via any combination of wired and/or wireless connections. Each component illustrated in FIG. 1 is discussed below.

In one or more embodiments, the vehicle (100) may represent any vehicle that has an associated vehicle identification number (VIN). The vehicle (100) may be, for example, a motor vehicle such as a truck, a car, a van, a sports utility vehicle, or any other motor vehicle. To that end, the vehicle (100) is capable of moving under its own power, the movement of which may be controlled by an operator.

In one or more embodiments, the vehicle (100) includes one or more sensors (140) which may collect data representative of the movement of the vehicle (100) including speed and acceleration along with a direction of the movement. For example, the one or more sensors (140) may include speedometers, accelerometers, gyroscopes, magnetometers, geolocation devices (e.g., a sensor that provides global positions (i.e., latitude and longitude coordinates) using any of the global navigation satellite systems, including GPS, BeiDou, Galileo, GLONASS, IRNSS, and QZSS), or any other type of sensor operable to measure movement. Further, the sensors (140) may be operably connected to the vehicle device (110).

In one or more embodiments, the vehicle device (110) is a computing device, such as an electronic control unit and/or electronic control module. In one or more embodiments, the vehicle device (110) controls one or more other components of the vehicle (100), and stores information about the vehicle (100) such as the VIN, data from the sensors (140), etc. Further, in one or more embodiments, the vehicle device (110) represents more than one computing device within the vehicle (100). Moreover, in one or more embodiments, the vehicle device (110) does not have any control functionality and is utilized to store information about the vehicle.

In one or more embodiments, the telematics device (120) is a computing device and is operatively coupled to the vehicle device (110). In one or more embodiments, the telematics device (120) is operatively coupled to the vehicle device (110) via an on-board diagnostics (OBD) port. In one or more embodiments, the telematics device (120) communicates with the vehicle device (110) to receive information such as the VIN, data from the sensors (140), etc. In one or more embodiments, the telematics device (120) includes one or more sensors that are operable to collect data representative of the movement of the vehicle (100) including speed and acceleration along with a direction of the movement. For example, the sensors included within the telematics device (120) may include speedometers, accelerometers, gyroscopes, magnetometers, geolocation devices (e.g., a sensor that provides global positions (i.e., latitude and longitude coordinates) using any of the global navigation satellite systems, including GPS, BeiDou, Galileo, GLONASS, IRNSS, and QZSS), or any other type of sensor operable to measure movement.

In one or more embodiments, the client device(s) (130) may be computing devices. Such computing devices may be referred to as endpoints. In one or more embodiments, an endpoint is any computing device, collection of computing devices, portion of one or more computing devices, or any other logical grouping of computing resources. In one or more embodiments, the client device(s) (130) may collectively be referred to as a client environment. In one or more embodiments, the client device(s) (130) represent one or more computing devices hosting a database (e.g., the product information catalog vehicle listing (vPIC) database) created and maintained by the National Highway Traffic Safety Administration (NHTSA) that include information about vehicles (e.g., vehicle (100)) based on a VIN associated with the vehicle.

Further, in one or more embodiments, the client device(s) (130) are devices that collect information from one or more telematics devices (e.g., telematics device (120)). Doing so may enable an organization to monitor multiple vehicles from a single device.

In one or more embodiments, the client device(s) (130) and the telematics device (120) are operatively connected, such as via a network (not shown), wired connections, Bluetooth, or any other suitable connection. In one or more embodiments, the network may represent a computing network configured for computing resources and/or messages to be exchanged among registered computing hosts (e.g., the client device(s) (130), the telematics device (120), etc.). As discussed above, components of the system may operatively connect to one another through the network (e.g., a LAN, a WAN, a mobile network, a wireless LAN (WLAN), etc.). In one or more embodiments, the network may be implemented using any combination of wired and/or wireless network topologies, and the network may be operably connected to the Internet or other networks. Further, the network may enable interactions between the client device(s) (130) and the telematics device (120) through any number and types of wired and/or wireless network protocols (e.g., TCP, UDP, Internet Protocol version 4 (IPv4), Internet Protocol version 6 (IPv6), etc.).

In one or more embodiments, a computing device is any device, portion of a device, or any set of devices capable of electronically processing instructions and may include, but is not limited to, any of the following: one or more processors (e.g. components that include integrated circuitry) (not shown), memory (e.g., random access memory (RAM)) (not shown), input and output device(s) (not shown), non-volatile storage hardware (e.g., solid-state drives (SSDs), hard disk drives (HDDs) (not shown)), one or more physical interfaces (e.g., network ports, storage ports) (not shown), any number of other hardware components (not shown) and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer and/or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), and/or any other type of computing device with the aforementioned requirements. In one or more embodiments, any or all of the aforementioned examples may be combined to create a system of such devices, which may collectively be referred to as a computing device. Other types of computing devices may be used without departing from the scope of the invention.

In one or more embodiments, the non-volatile storage (not shown) and/or memory (not shown) of a computing device or system of computing devices may be one or more data repositories for storing any number of data structures storing any amount of data (i.e., information). In one or more embodiments, a data repository is any type of storage unit and/or device (e.g., a file system, database, collection of tables, RAM, and/or any other storage mechanism or medium) for storing data. Further, the data repository may include multiple different storage units and/or devices. The multiple different storage units and/or devices may or may not be of the same type or located at the same physical location.

In one or more embodiments, a computing device includes and/or is operatively connected to any number of storage volumes (not shown). In one or more embodiments, a volume is a logically accessible storage element of a computing system. A volume may be part of one or more disk drives, and may or may not include any number of partitions. In one or more embodiments, a volume stores information relevant to the operation and/or accessible data of a computing device. In one or more embodiments, a volume may be all or part of any type of computing device storage (described above).

In one or more embodiments, any non-volatile storage (not shown) and/or memory (not shown) of a computing device or system of computing devices may be considered, in whole or in part, as non-transitory computer readable mediums storing software and/or firmware.

Such software and/or firmware may include instructions which, when executed by the one or more processors (not shown) or other hardware (e.g., circuitry) of a computing device and/or system of computing devices, cause the one or more processors and/or other hardware components to perform operations in accordance with one or more embodiments described herein.

The software instructions may be in the form of computer readable program code to perform methods of embodiments as described herein, and may, as an example, be stored, in whole or in part, temporarily or permanently, on a non-transitory computer readable medium such as a compact disc (CD), digital versatile disc (DVD), storage device, diskette, tape storage, flash storage, physical memory, or any other non-transitory computer readable medium.

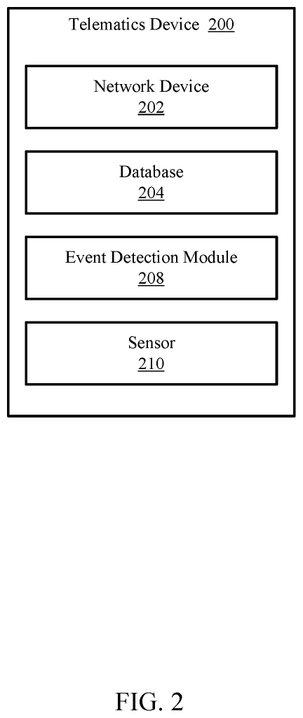

Turning to FIG. 2, FIG. 2 shows an example telematics device (200) (e.g., telematics device (120), FIG. 1) in accordance with one or more embodiments. In one or more embodiments, the telematics device (200) includes a network device (202), a database (204), an event detection module (208), and/or a sensor (210). The telematics device (200) may include additional, fewer, and/or different components without departing from the scope of the disclosure. Each component may be operably connected to any of the other components via any combination of wired and/or wireless connections. Each component illustrated in FIG. 2 is discussed below.

In one or more embodiments, the network device (202) includes functionality to communicate with other devices to send and receive information from the telematics device (200). In one or more embodiments, the network device (202) is operable to communicate via wired, wireless, or a combination of wired and wireless networks to send and receive information. For example, the network device (202) may communicate with a vehicle device (e.g., vehicle device (110), FIG. 1) to receive a VIN associated with a vehicle. The network device (202) may further use this VIN and communicate with another device that hosts a vPIC database (e.g., via a vPIC application programming interface (API)) or any other database that contains information about a vehicle based on its VIN to request and receive additional information about the vehicle associated with the VIN. Further, in one or more embodiments, the network device (202) is operable to send information stored in the database (204) and/or stream data collected by the sensor (210) (e.g., in real-time or at intervals). In one or more embodiments, the network device (202) may be implemented as any combination of network devices (e.g., switch, router, multi-layer switch, etc.).

In one or more embodiments, the database (204) is operable to store (temporarily or permanently) unstructured and/or structured data that may include (or specify), for example (but not limited to): details of events detected by the event detection module (208) (the details of which are described below), data collected by the sensor (210), sets of event detection parameters, the vPIC database, VINs, data received by the network device (202) (e.g., details about a vehicle associated with a VIN), or any other information described herein. In embodiments in which the database (204) stores the vPIC database, the event detection module (208) may utilize the vPIC database stored in the database (204) and may not utilize the network device (202) to retrieve vehicle information from another device.

In one or more embodiments, the database (204) may be a fully managed, local, and lightweight database (or any logical container such as SQLite database) that acts as a shared storage or memory resource (discussed above) that is functional to store unstructured and/or structured data. Further, the database (204) may also occupy a portion of a physical storage/memory device or, alternatively, may span across multiple physical storage/memory devices.

In one or more embodiments, the database (204) may be implemented using physical devices that provide data storage services (e.g., storing data and providing copies of previously stored data). The devices that provide data storage services may include hardware devices and/or logical devices. For example, the database (204) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the database (204) may include a memory device (e.g., a dual in-line memory device), in which data is stored and from which copies of previously stored data are provided. As yet another example, the database (204) may include a persistent storage device (e.g., an SSD), in which data is stored and from which copies of previously stored data is provided. As yet another example, the database (204) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the database (204) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

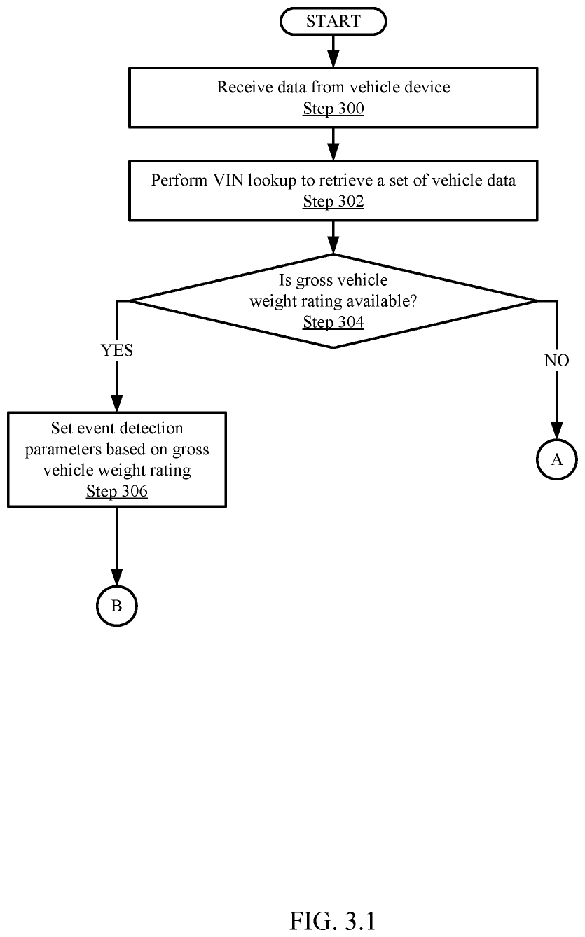

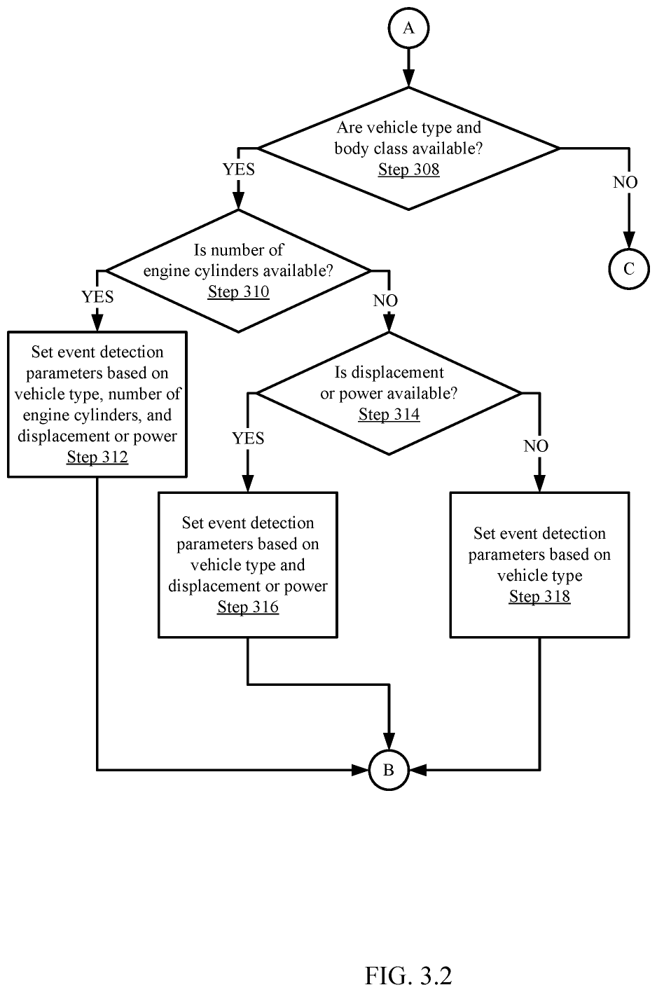

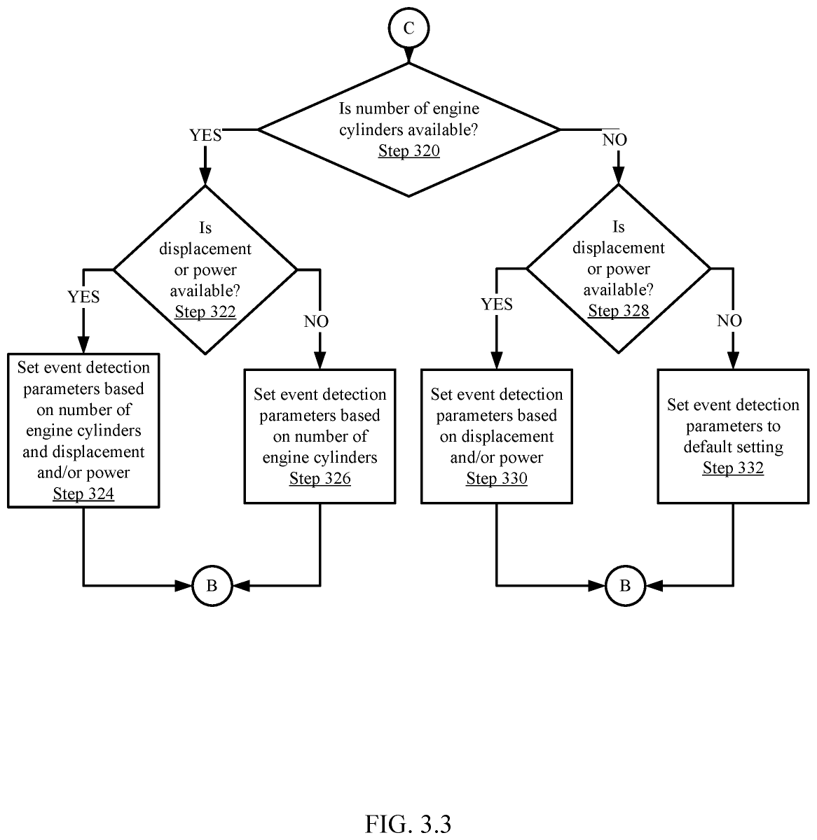

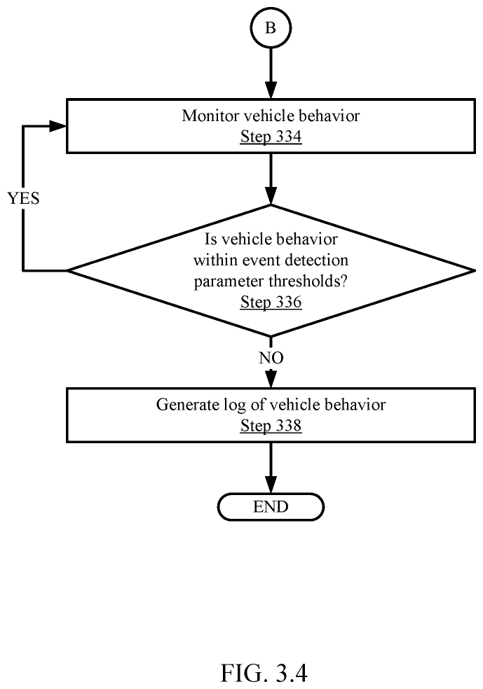

In one or more embodiments, the event detection module (208) is operable to set event detection parameters, detect an event having conditions that exceed one or more thresholds of the set event detection parameters, and determine which details about the event should be stored in the database (204) and/or sent to another device via the network device (202). Additional details about the operation of the event detection module (208) may be found below in describing FIGS. 3.1-3.3.

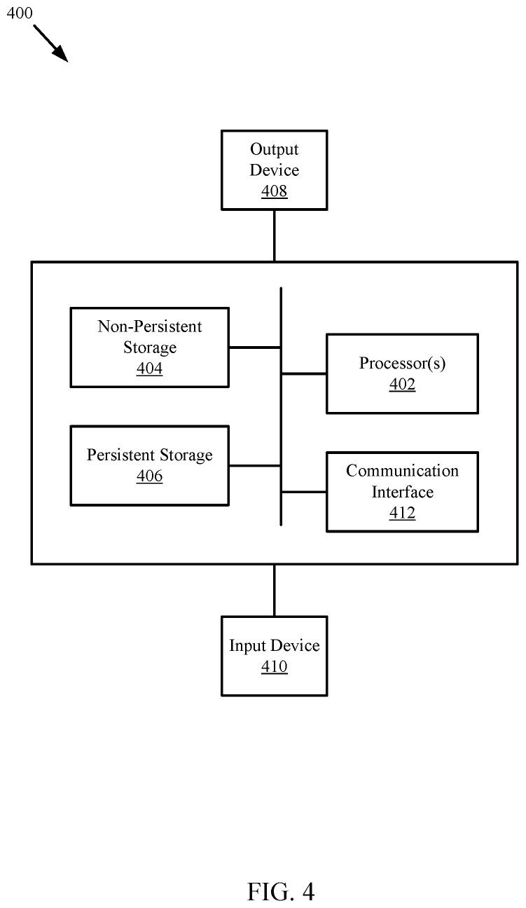

In one or more embodiments, the event detection module (208) is implemented as a computing device (see e.g., FIG. 4). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the event detection module (208) described throughout this application and/or all, or a portion thereof, of the method illustrated in FIGS. 3.1-3.3.

In one or more embodiments, the sensor (210) include any number of sensors and any number of each type of sensor described herein. The sensor (210) is operable to collect data representative of the movement of a vehicle (e.g., vehicle (100), FIG. 1) including speed and acceleration along with a direction of movement of the vehicle. For example, the sensor (210) may include speedometers, accelerometers, gyroscopes, magnetometers, geolocation devices, or any other type of sensor operable to measure movement. Further, the accelerometer is operable to provide acceleration data and may be operable to detect acceleration along any number of axes, including one axis, two axes, three axes, or more axes.

Turning to FIGS. 3.1-3.4, FIGS. 3.1-3.4 show a flowchart describing a method for automatically calibrating a telematics device by setting event detection parameters and detecting events that exceed one or more threshold of the event detection parameters in accordance with one or more embodiments disclosed herein. The method may be performed by, for example, the telematics device (200, FIG. 2).

In one or more embodiments, the method provided in reference to FIGS. 3.1-3.4 may enable a telematics device receive information from a vehicle device of a vehicle (e.g., a VIN) and automatically retrieve additional information about the vehicle based on the information from the vehicle device. Then, the telematics device determines which types of information are available in the additional information and sets a group of event detection parameters based on the available additional information. Next, the telematics device monitors the vehicle behavior and logs events in which the vehicle behavior exceeds one or more of the group of event detection parameters.

Doing so enables a single configuration of a telematics device to be operably connected to any type of vehicle and set a group of event detection parameters automatically, without user input, and then monitor the vehicle behavior using the group of event detection parameters. This method may enable a manager of multiple vehicles to use a single telematics device to detect events of interest. Further, this method may enable a single telematics device to be moved to different vehicles and update the group of event detection parameters each time the telematics device is operably connected to a new vehicle.

While the various steps in the flowchart shown in FIGS. 3.1-3.4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

Starting with the steps illustrated in FIG. 3.1, in step 300, the telematics device receives data from a vehicle device (e.g., 110, FIG. 1). In one embodiment, the data includes a VIN associated with a vehicle (e.g., 100, FIG. 1) that includes the vehicle device. Further, as described above, the telematics device may be coupled to the vehicle via a wired (e.g., via an OBD port) and/or wirelessly.

In step 302, the telematics device performs a VIN lookup to retrieve a set of vehicle data associated with the VIN received in step 300. In one or more embodiments, the telematics device communicates with another device to perform the VIN lookup. For example, the telematics device communicates with a device that hosts a vPIC database (e.g., via a vPIC application programming interface (API)) to request and receive the set of vehicle data associated with the VIN. In one or more embodiments, the telematics device may store a copy of the vPIC database and may perform a VIN lookup using the locally stored vPIC database. In one or more embodiments, the vPIC database associates the VIN with one or more of the following types of information: gross vehicle weight rating (GVWR), vehicle type and/or body class (e.g., passenger car, sedan, hatchback, coupe, truck, multi-purpose vehicle, heavy duty, incomplete, or any other type and/or body class of vehicle), number of engine cylinders, engine displacement, engine power, or any other attribute of a vehicle.

In step 304, the telematics device determines whether the GVWR is included in the set of vehicle data retrieved in step 302. If the GVWR is included the set of vehicle data, the method proceeds to step 306. If the GVWR is not included in the set of vehicle data, the method proceeds to step 308 (FIG. 3.2).

In step 306, the telematics device sets one or more event detection parameters based on the GVWR. In one or more embodiments, the telematics device stores one or more groups of event detection parameters, in which each group includes the same type of parameters, but different threshold values for each parameter. For example, the telematics device may store six groups of event detection parameters. In one or more embodiments, the GVWR is indicative of a class-size of vehicle ranging from 1 to 8 and each class may be split into subclasses (e.g., class 2 may range from class 2A to class 2H). Further, each group of event detection parameters correspond to one or more classes and/or subclasses of vehicle classes. For example, a first group of event detection parameters may correspond to vehicles in class 1A, a second group of event detection parameters may correspond to classes 1B and 1C, a third group of event detection parameters may correspond to classes 1D through 2E, a fourth group of event detection parameters may correspond to classes 2F through 2H, a fifth group of event detection parameters may correspond to class 3, and a sixth group of event detection parameters may correspond to every other class. In such an example, the telematics device would set the event detection parameters to the values found in the first group for a vehicle having a GVWR in class 1A.

In one or more embodiments, the types of parameters includes speed, idle time, acceleration, acceleration duration (i.e., time spent above an acceleration threshold), deceleration, deceleration duration (i.e., time spent above a deceleration threshold), lateral acceleration, lateral acceleration duration (i.e., time spent above a lateral acceleration threshold), impact, and impact duration (i.e., time spent above an impact threshold). In one or more embodiments, the values of the thresholds of the parameters are based, at least in part, on a size or estimated size of the vehicle. Because smaller and/or lighter vehicles are able to experience greater changes in velocity with less force, the corresponding parameters may be adjusted accordingly. For example, a compact sports car is much more likely to be capable of safely handling greater changes in velocity than a large truck. The method then proceeds to step 334 (FIG. 3.4), which is discussed below.

Turning to FIG. 3.2, in step 308, the telematics device determines whether the vehicle type and/or body class is available in the set of vehicle data. If the vehicle type and/or body class is included the set of vehicle data, the method proceeds to step 310. If the vehicle type and/or body class is not included in the set of vehicle data, the method proceeds to step 320 (FIG. 3.3).

In step 310, the telematics device determines whether the number of engine cylinders is available in the set of vehicle data. If the number of engine cylinders is included the set of vehicle data, the method proceeds to step 312. If the number of engine cylinders is not included in the set of vehicle data, the method proceeds to step 314.

In step 312, the telematics device sets one or more event detection parameters based on the vehicle type and/or body class and the number of engine cylinders. For example, the telematics device sets a first group of event detection parameters for a coupe having six or more cylinders and a second group of event detection parameters for a truck having four cylinders. In one or more embodiments, the telematics device may also utilize engine displacement and/or engine power to select a group of event detection parameters. In such an embodiment, the telematics device sets one or more event detection parameters based on the vehicle type and/or body class, the number of engine cylinders, and engine displacement and/or engine power. The method then proceeds to step 334 (FIG. 3.4), which is discussed below.

In step 314, the telematics device determines whether engine displacement or engine power is available in the set of vehicle data. If engine displacement or engine power is included the set of vehicle data, the method proceeds to step 316. If engine displacement and engine power are not included in the set of vehicle data, the method proceeds to step 318.

In step 316, the telematics device sets one or more event detection parameters based on the vehicle type and/or body class and engine displacement and/or engine power. For example, the telematics device sets a first group of event detection parameters for a coupe having a displacement above 2.0 liters or more than 150horsepower and a second group of event detection parameters for a truck having a displacement above 6.0 liters. The method then proceeds to step 334 (FIG. 3.4), which is discussed below.

In step 318, the telematics device sets one or more event detection parameters based on the vehicle type and/or body class alone. For example, the telematics device sets a first group of event detection parameters for a coupe and a second group of event detection parameters for a truck. The method then proceeds to step 334 (FIG. 3.4), which is discussed below.

Turning to FIG. 3.3, in step 320 the telematics device determines whether the number of engine cylinders is available in the set of vehicle data. If the number of engine cylinders is included in the set of vehicle data, the method proceeds to step 322. If the number of engine cylinders is not included in the set of vehicle data, the method proceeds to step 328.

In step 322, the telematics device determines whether engine displacement or engine power is available in the set of vehicle data. If engine displacement or engine power is included the set of vehicle data, the method proceeds to step 324. If engine displacement and engine power are not included in the set of vehicle data, the method proceeds to step 326.

In step 324, the telematics device sets one or more event detection parameters based on the number of engine cylinders and engine displacement and/or engine power. For example, the telematics device sets a first group of event detection parameters for a vehicle having four cylinders and a displacement less than 2.5liters and more than 200 horsepower, and a second group of event detection parameters for a vehicle having eight cylinders and a displacement above 6.0 liters. The method then proceeds to step 334 (FIG. 3.4), which is discussed below.

In step 326, the telematics device sets one or more event detection parameters based on the number of engine cylinders. For example, the telematics device sets a first group of event detection parameters for a vehicle having four cylinders, and a second group of event detection parameters for a vehicle having eight cylinders. The method then proceeds to step 334 (FIG. 3.4), which is discussed below.

In step 328, the telematics device determines whether engine displacement or engine power is available in the set of vehicle data. If engine displacement or engine power is included the set of vehicle data, the method proceeds to step 330. If engine displacement and engine power are not included in the set of vehicle data, the method proceeds to step 332.

In step 330, the telematics device sets one or more event detection parameters based on engine displacement and/or engine power. For example, the telematics device sets a first group of event detection parameters for a vehicle having four cylinders and a displacement less than 4.0 liters and/or less than 400 horsepower and a second group of event detection parameters for a vehicle having eight cylinders and/or a displacement above 6.0 liters. The method then proceeds to step 334 (FIG. 3.4), which is discussed below.

In step 332, the telematics device sets one or more event detection parameters to default settings. For example, if limited and/or no information is available about a vehicle, then certain default settings may be utilized. The default settings may be pre-set and may be chosen to apply to as broad of a range of vehicles as possible. In one or more embodiments, the default settings may be customized by a customer and/or be based on common attributes for a particular set (e.g., fleet) of vehicles.

Turning to FIG. 3.4, in step 334, the telematics device monitors vehicle behavior, such as the velocity and/or change in velocity (i.e., acceleration) of the vehicle. In one or more embodiments, the telematics device utilizes one or more sensors included within the telematics device (e.g., sensor (210), FIG. 2) and/or one or more sensors included within the vehicle (e.g., sensors (140), FIG. 1). Further, the telematics device may monitor the vehicle behavior constantly (i.e., in real-time) and/or at intervals of time.

In step 336, the telematics device determines whether the vehicle behavior is within the set event detection parameters. If the telematics device determines that the vehicle behavior is within the set event detection parameters, the method returns to step 334 and the telematics device continues to monitor the vehicle behavior. If the telematics device determines that the vehicle behavior is outside/exceeds one or more of the event detection parameters, the method continues to step 338. For example, if the vehicle may be travelling at a high rate of speed that exceeds a velocity threshold, then the method proceeds to step 338. In another example, the vehicle may be stopped and accelerates to reach a cruising speed, but, in doing so, the vehicle exceeds an acceleration threshold, but only for a period of time that is less than the acceleration duration threshold. In such an example, the method may not proceed to step 338 and instead returns to step 334. In a further example, a vehicle experiences a crash which may cause one or more of the impact threshold, the impact duration threshold, the acceleration threshold, the acceleration duration threshold, the deceleration threshold, the deceleration duration threshold, the lateral acceleration threshold, and the lateral acceleration duration threshold to be exceeded. In this example, the method may proceed to step 338.

In step 338, the telematics device generates a log of the vehicle behavior. In one or more embodiments, the log includes the vehicle behavior while the vehicle behavior exceeds one or more of the event detection parameters, for a period of time before the vehicle behavior exceeds one or more of the event detection parameters, and/or for a period of time after the behavior exceeds one or more of the event detection parameters. In one or more embodiments, the log may include additional information, such as location, time of day, etc. about the vehicle before, during, and/or after the vehicle behavior exceeds one or more of the event detection parameters. Further, in one or more embodiments, the telematics device may store the log in a local storage (e.g., database (204), FIG. 2) and/or send the log to another device (e.g., via the network device (202), FIG. 2).

The method may end following step 338 and/or return to step 334 to continue monitoring vehicle behavior.

As discussed above, embodiments of the invention may be implemented using computing devices. FIG. 4 shows a diagram of a computing device (400) in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) (402) may be one or more cores or micro-cores of a processor. The computing device (400) may also include one or more input devices (410), such as a touchscreen, keyboard, mouse, microphone, touchpad, electronic pen, or any other type of input device. The communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (408, 410) may be locally or remotely connected to the computer processor(s) (402), non-persistent storage (404), and persistent storage (406). Many diverse types of computing devices exist, and the aforementioned input and output device(s) (408, 410) may take other forms.

The problems discussed above should be understood as being examples of problems solved by embodiments of the invention and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for automatically calibrating a telematics device in a vehicle, the method comprising:
obtaining, from a vehicle device of the vehicle, a vehicle identification number (VIN);
retrieving a set of vehicle data using the VIN;
determining whether a gross vehicle weight rating (GVWR) is included in the set of vehicle data;
setting a first group of event detection parameters for the telematics device based on the GVWR if the GVWR is included in the set of vehicle data;
determining whether a vehicle type or a body class is included in the set of vehicle data if the GVWR is not included in the set of vehicle data;
determining whether a number of engine cylinders is included in the set of vehicle data if the GVWR is not included in the set of vehicle data;
setting a second group of event detection parameters based on the vehicle type or the body class and number of engine cylinders if the vehicle type or the body class and the number of engine cylinders are included in the set of vehicle data;
determining whether an engine displacement or an engine power is included in the set of vehicle data if the vehicle type or the body class is included in the set of vehicle data and the number of engine cylinders is not included in the set of vehicle data or if the vehicle type or the body class is not included in the set of vehicle data;
setting a third group of event detection parameters based on the vehicle type or the body class and the engine displacement or the engine power if the vehicle type or the body class and the engine displacement or the engine power is included in the set of vehicle data and the number of engine cylinders is not included in the set of vehicle data;
setting a fourth group of event detection parameters based on the vehicle type or the body class if the vehicle type or the body class is included in the set of vehicle data and the number of engine cylinders, the engine displacement, and the engine power are not included in the set of vehicle data;
setting a fifth group of event detection parameters based on the number of engine cylinders and the engine displacement or the engine power if the number of engine cylinders and the engine displacement or the engine power are included in the set of vehicle data and the vehicle type and the body class are not included in the set of vehicle data;
setting a sixth group of event detection parameters based on the number of engine cylinders if the number of engine cylinders is included in the set of vehicle data and the vehicle type, the body class, the engine displacement, and the engine power are not included in the set of vehicle data;
setting a seventh group of event detection parameters based on the engine displacement or the engine power if the engine displacement or the engine power are included in the set of vehicle data and the vehicle type, the body class, and the number of engine cylinders are not included in the set of vehicle data; and
setting an eighth group of event detection parameters to a default setting if the vehicle type, the body class, the number of engine cylinders, the engine displacement, and the engine power are not included in the set of vehicle data.

2. The method of claim 1, further comprising:
monitoring, using the telematics device, vehicle behavior of the vehicle;
making a determination, based on the monitoring, that a threshold value of a parameter of a set one of the first group, the second group, the third group, the fourth group, the fifth group, the sixth group, the seventh group, and the eighth group has been exceeded; and
generating, in response to the determination, a log of vehicle behavior.

3. The method of claim 1, wherein the first group, the second group, the third group, the fourth group, the fifth group, the sixth group, the seventh group, and the eighth group comprise at least one of the following: speed, idle time, acceleration, acceleration duration, deceleration, deceleration duration, lateral acceleration, lateral acceleration duration, impact, and impact duration.

4. A method for automatically calibrating a telematics device in a vehicle, the method comprising:
obtaining a vehicle identification number (VIN);
retrieving a set of vehicle data using the VIN;
making a first determination that a first portion of vehicle characteristic data is included in the set of vehicle data; and
setting event detection parameters for the telematics device based on the first portion of vehicle characteristic data.

5. The method of claim 4, wherein vehicle characteristic data comprises gross vehicle weight rating, vehicle type, body class, engine displacement, engine power, and number of engine cylinders.

6. The method of claim 5, wherein the first portion comprises gross vehicle weight rating.

7. The method of claim 5, further comprising:
making a second determination that a second portion of vehicle characteristic data is not included in the set of vehicle data.

8. The method of claim 7, wherein the second portion comprises gross vehicle weight rating and the first portion comprises vehicle type.

9. The method of claim 8, wherein the second portion further comprises number or engine cylinders, engine displacement, and engine power.

10. The method of claim 7, wherein the second portion comprises gross vehicle weight rating, vehicle type, and body class and the first portion comprises number of engine cylinders.

11. The method of claim 7, wherein the second portion comprises gross vehicle weight rating, vehicle type, body class, and number of engine cylinders, and the first portion comprises engine displacement and engine power.

12. The method of claim 4, wherein the event detection parameters comprise at least one of the following: speed, idle time, acceleration, acceleration duration, deceleration, deceleration duration, lateral acceleration, lateral acceleration duration, impact, and impact duration.

13. The method of claim 12, further comprising:
monitoring, using the telematics device, vehicle behavior of the vehicle;
making a second determination that a threshold value of the event detection parameters has been exceeded based on the monitoring; and
generating, in response to the second determination, a log of vehicle behavior.

14. The method of claim 13, wherein the log comprises at least a portion of the event detection parameters for a period of time surrounding the second determination.

15. A system for automatically monitoring vehicle behavior, the system comprising:
a telematics device communicatively coupled to a vehicle, the telematics device comprising:
a memory; and
a processor programmed to:
obtain, from a vehicle device of the vehicle, a vehicle identification number (VIN);
retrieve a set of vehicle data using the VIN;
make a first determination that a first portion of vehicle characteristic data is not included in the set of vehicle data;
set, in response to the first determination, event detection parameters for the telematics device;
monitor, after the setting and using the telematics device, vehicle behavior of the vehicle;
make a second determination that a threshold value of the event detection parameters has been exceeded based on the monitoring; and
generate, in response to the second determination, a log of vehicle behavior.

16. The system of claim 15, further comprising:
making a third determination that a second portion of vehicle characteristic data is included in the set of vehicle data,
wherein the event detection parameters are based on the third portion of vehicle characteristic data, and
wherein vehicle characteristic data comprises gross vehicle weight rating, vehicle type, body class, engine displacement, engine power, and number of engine cylinders.

17. The system of claim 16, wherein the first portion comprises gross vehicle weight rating and the second portion comprises vehicle type.

18. The system of claim 17, wherein the first portion further comprises number or engine cylinders, engine displacement, and engine power.

19. The system of claim 16, wherein the first portion comprises gross vehicle weight rating, vehicle type, and body class and the second portion comprises number of engine cylinders.

20. The system of claim 16, wherein the first portion comprises gross vehicle weight rating, vehicle type, body class, and number of engine cylinders, and the second portion comprises engine displacement or engine power.
